(19) United States
(12) Patent Application Publication
(10) Pub. No.: US 2005/0077843 A1
(43) Pub. Date: Apr. 14, 2005

(54) Method and apparatus for controlling a performing arts show by an onstage performer

(76) Inventor: Ronnie Benditt, Horsham, PA (US)

Correspondence Address: Ronnie Benditt, 2D, 310 Saw Mill Lane, Horsham, PA, 19044, US

(21) Appl. No.: 10/684,245

(22) Filed: Oct. 11, 2003

(51) Int. Cl. H05B 37/00

(52) U.S. Cl. 315/312; 315/82

(57) ABSTRACT

A method and apparatus for the control of a performing arts show is described where play lists containing audio tracks, light events, and lyric display events are streamed by a computer and mixed with stage-performed audio. An onstage bank of switches is used to control the play list remotely by a performer. Light brightness, color, and position are synchronized to the audio tracks of the play list in order to create light scenes onstage that correspond to the audio tracks being played. Also synchronized with the audio tracks is the display of song lyric text on the computer screen in order to serve as a reminder to the performer and to give a visual cue of the position of the audio track. Such a system enables musicians to perform along with backing audio while presenting a light show to the audience without the need for dedicated lighting personnel.

### BACKGROUND OF THE INVENTION

The present invention pertains generally to performing arts show control equipment, and more particularly to the control of audio, lighting, and lyrics display.

Many performing-artists use background music as part of their show. For example, a singing guitar player may play along with pre-recorded drums during the show. It has become very common for musicians to use a computer running software that allows them to define play lists of background music. What is lacking, however, is a means of controlling the play list remotely while performing. Performers must either use keyboard presses or mouse movements and clicks on the computer to control their show or let their show run straight through with no interaction at all. From the point of view of the audience, such computer interaction tends to be very distracting from the show.

There does exist in prior art, many digital dictograph machines and transcribers that record and play back digital audio that are foot operated. Such machines are designed for business recording purposes and not for use in performing arts. As such, no provisions are made to control play lists of songs in a manner suitable for a show performance.

Lighting is another important aspect of many performing-artists' shows. Presently there are a number of light control schemes in common use. The primary emphasis of most currently available lighting controllers is on devices that require dedicated lighting personnel to control the light show, with very few performer-controlled systems in existence. There are, however, a few systems that do allow light scenes to be created and programmed into a foot-operated bank of switches. The light shows made with these types of systems are not programmed in context to background music, but instead are either static light scenes, or some of the lights can be made to perform in sound-activated mode, where the lights react to the sounds that they hear with microphones. While sound-activated lighting does make for dynamic light shows, the lighting events are not entirely pre-programmed and therefore may be somewhat unpredictable in their playback. These systems are clearly meant for controlling light shows only—not for controlling the playback of audio as well.

There are a few light control systems on the market that do link up with audio play lists. Most of those systems do not have the audio portion of their system integrated, but rather rely on the linking of a light controller program with another program that takes care of the audio playback. Further, there is no provision for a performing-artist to control neither the audio nor the lights in an elegant manner while performing, but must instead either rely on a dedicated light operator to control the show or must allow the program to run from start to completion without any interaction at all.

One light control system, as implemented by Chauvet Lighting, allows for multi-scene light shows to be created and timed to an audio file. This “show” is then assigned to a pushbutton switch on a control surface so that the light show operator may switch between shows by pressing buttons. A schematic of this system is presented in FIG. 3. Because a “play list” approach is not used, the number of audio tracks is limited to the number of switches on the control surface. Further, only very rudimentary control is provided at the control surface itself. Perhaps the biggest limitation of this system is that the switches on the control surface are not intended to be operated by foot, but rather by finger press. This makes it very difficult for a performer to use while performing.

Another aspect of a show that has been long neglected is the display of lyrics. Lyric display is commonplace in karaoke-type shows, where singing is done to background audio tracks. In these systems, the singer is not in control of the show at all, but rather an operator behind the scenes controls the starting, stopping, and volume level of the show. There currently is no provision for a solo performer to have lyric cues in a system that the performer can control elegantly onstage.

Hence, a system and method would be desirable that would incorporate audio playback with synchronized lighting and lyric displays in a manner that is controllable by a performer onstage.

### BRIEF SUMMARY OF THE INVENTION

The present invention is a system for controlling the playback of audio, light sequences, and lyric displays while a performing-artist performs on stage. The invention consists of a computer for arranging and playing back a play list of audio, lights, and lyrics, a switch box connected to the computer to remotely control the show from on stage, and an electronic light controller embedded in the switch box that controls the lights' intensities and colors based upon the commands from the computer.

### BRIEF DESCRIPTION OF THE SEVERAL VIEWS OF THE DRAWING

FIG. 1 shows a cut-away perspective view of a show controller system

FIG. 2 shows a schematic of show control methodology

FIG. 3 shows a schematic of prior art show control methodology

FIGS. 4A and 4B show a flowchart of show control operation

FIG. 5 shows a flowchart of circuit board firmware

FIG. 6 shows a cut-away perspective view of a show controller system with computer, mixer, and amplification integrated into foot pedal

FIG. 7 shows a cut-away perspective view of a show controller system with video projector and wireless interface

### DETAILED DESCRIPTION OF THE INVENTION

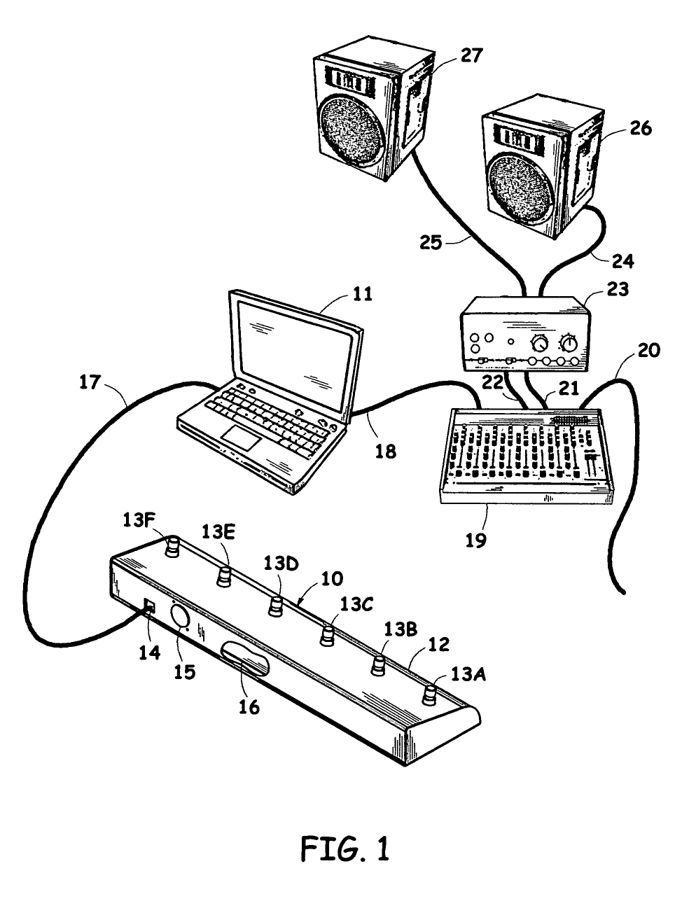

A preferred embodiment of the present invention is illustrated in FIG. 1. A controller assembly 10 consists of an enclosing housing 12, a circuit board 16, a series of switches 13A thru 13F, a computer connector 14, and a light connector 15. The controller assembly 10 is connected by a cable 17 to a computer 11. The audio from computer 11 is fed by computer audio cable 18 to an audio mixer 19. Additional live audio is also fed into mixer 19 by live audio cable 20. Audio mix cables 21 and 22 supply mixed audio from the mixer 19 to an audio amplifier 23. Speaker cables 24 and 25 supply amplified audio to speakers 26 and 27.

In operation, computer 11 controls the streaming of a play list 39 that contains audio files, light events, and lyric display events. The audio that is played by computer 11 is mixed with audio that is being generated by onstage performers and amplified. The play list 39 can be controlled onstage by the foot switches provided in controller assembly 10. Functions that may be controlled by the switches 13A thru 13F include the starting and stopping of the audio, selection of the play list item, and audio volume level. It is conceivable that multiple live audio sources may be connected to mixer 19 so as to mix multiple live audio sources with the play list audio tracks.

The light events that are streaming from the play list 39 are transmitted to a circuit board 16 that generates an electronic protocol to control stage lighting (not shown) that connects to light connector 15. The most popular light control protocol in use today is the DMX512 standard as set forth by the United States Institute of Theatre Technology (USITT). Such a system is very flexible and commonly allows for the brightness, color, and position of lights to be controlled. Other similar lighting protocols may be used as well, such as MIDI show control.

In addition to the audio and light events, computer 11 also streams lyric display events from the play list 39. When the audio is playing, lyric text is displayed on the screen of computer 11 in synchronization with the play list audio to provide a visual cue to onstage performers.

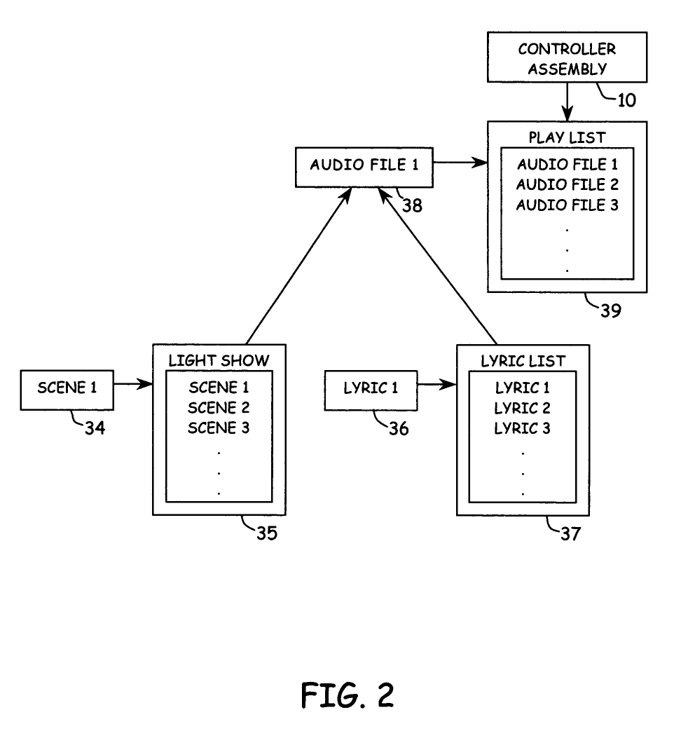

The methodology of how a show is constructed and controlled is illustrated in FIG. 2. A light scene 34 is defined in a computer program running on computer 11 and it is assigned, along with others, to a light show 35. Light show 35 list is assigned to an audio file 38. Similarly, lyric text 36 is compiled in a lyric list 37 that is assigned to audio file 38. Audio file 38 is then assigned to a play list 39, which also contains other audio files 38 that have their light show 35 and lyric lists 37 similarly assigned to them. Controller 10 starts and stops the play list 39 playback. Because a play list 39 exists in this methodology, the entire performance is defined from start to finish and computer 11 can control the entire performance without user action if so desired. Also, controller 10 can be used to set volume levels of the audio file 38 as well as choose or skip specific play list items if warranted.

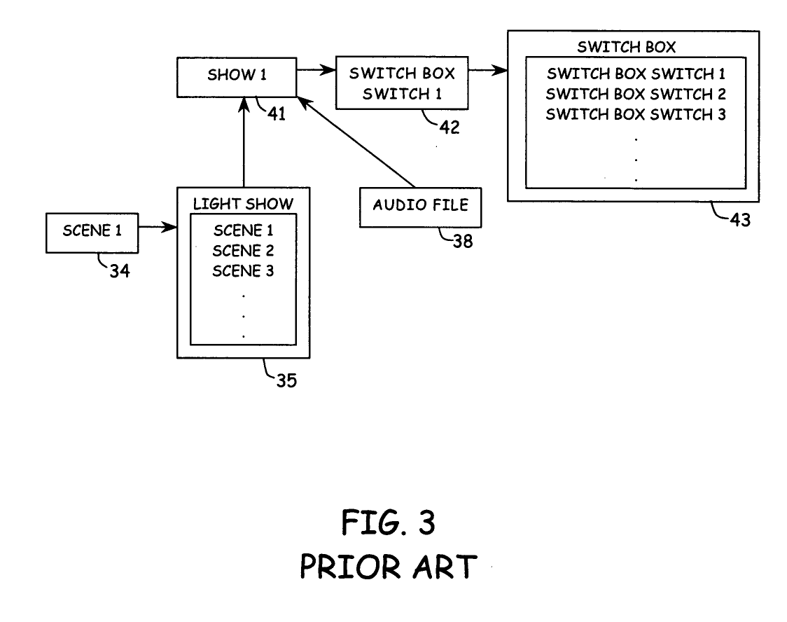

In contrast, prior art show control, as implemented by Chauvet Lighting, works in a different way, as illustrated in FIG. 3. A scene 34 is defined in a computer program and is assigned, along with others, to a light show 35. The light show 35, along with an audio file 38, comprises a show 41. The show 41 is then assigned to a controller switch 42 on a controller 40. In this system, shows are switched by pressing a switch 42 on controller 40. A performance is therefore limited to the number of switches 42 contained on controller 40. Further, because there is no play list 39, it is up to the performer to manually switch the show 41 at the currently running show's 41 conclusion.

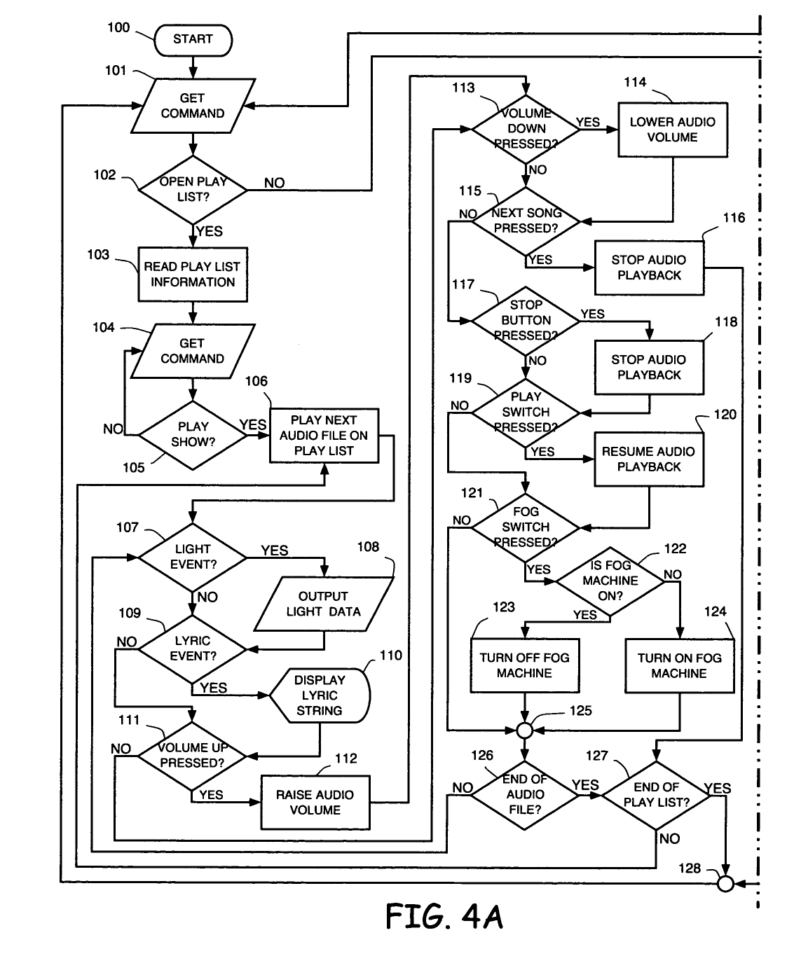

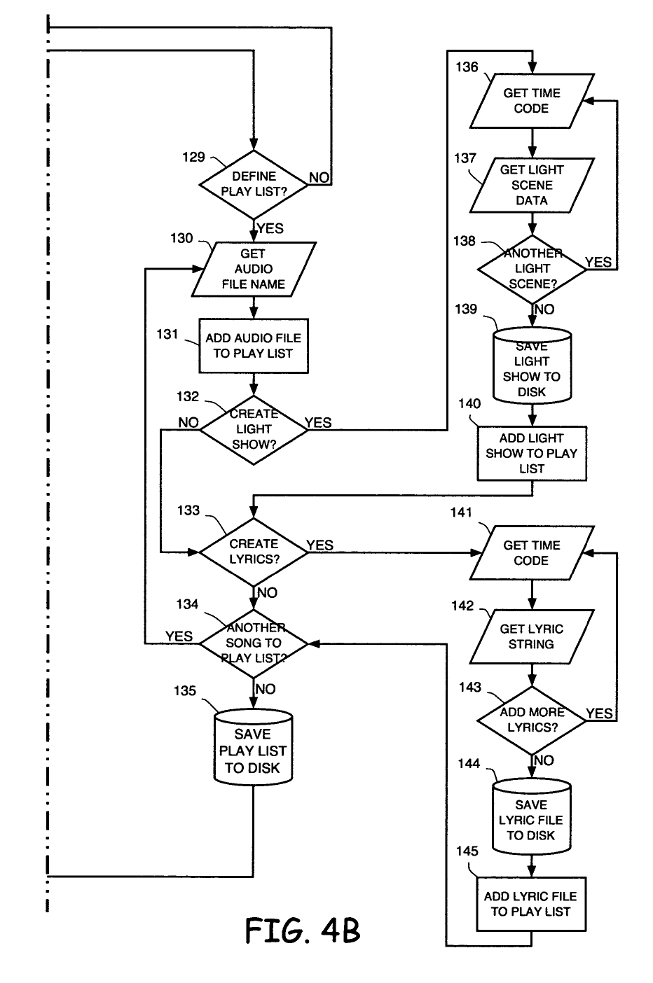

The software used to control the show of the present invention is flowcharted in FIGS. 4A and 4B. After the start 100 of the program, the user issues a command at operation 101 to either open a play list or define a play list. If the user chooses to define a play list, operation 129, the user must then select an audio file at operation 130 that will be added to the play list at operation 131. The user will then be given the opportunity to add a light show to correspond to the audio file in operation 132.

To create a light show, in operation 136 the user must designate the time code of the audio file for which a “light event” is to occur. The user then enters in data in operation 137 to define the light scene. The user may enter additional light scenes to synchronize to the audio time code if required in operation 138. After the complete light show is defined, it is saved to disk in operation 139 and added to the play list in operation 140.

The option to create lyric displays will be presented in operation 133. To define a lyric display, the user enters the time code from the audio file at operation 141 and enters a lyric string to be displayed at that time in operation 142. The user may add additional lyrics to synchronize with the audio time code if required in operation 143. When complete, the lyric file is saved to disk in operation 144 and added to the play list in operation 145.

Additional songs may similarly be added to the play list in operation 134 to build up a complete show. When the play list is complete, it is saved to disk in operation 135 for later playback.

When the user chooses to open a play list for playback in operation 102, the play list file is read and assembled into a time-sequenced listing in memory at operation 103. The program then waits for the user to enter a command in operation 104 to play the show. When the command to play the show is received in operation 105, the next audio file on the play list is played in operation 106. The time code of the audio file is compared against the time code of the next light event in operation 107. When a light event is to occur, the light data is output to the controller 10 in operation 108 for processing and further output to the lighting system by way of the light connector 15.

Similarly, the program compares the audio file's time code against the next lyric display event in operation 109. If a lyric needs to be displayed, the lyric string is output to computer 11's screen in operation 110.

The computer program scans controller 10 for switch 13A thru 13F presses. If the volume up switch is pressed at operation 111, computer 11 raises the volume of the audio in operation 112. Similarly, if the volume down switch is pressed at operation 113, computer 11 lowers the volume of the audio in operation 114.

One switch 13A thru 13F of the controller 10 may be used to designate a change in play list item. When this switch is pressed during operation 115, the audio is stopped in operation 116, and if the end of the play list is not reached in operation 127, the next audio file on the play list is played at operation 106. If the end of the audio list has been reached in operation 127, the show is stopped, waiting for user action at operation 101.

If the stop switch is pressed during operation 117, the audio playback is stopped at operation 118 and the program waits until the play switch is pressed at operation 119. It is anticipated that the stop and the play switch can be the same switch 13A as only one is valid at any given time. When the play switch is pressed during operation 119, the audio playback is resumed at operation 120.

Switch 13F is designated as a fog switch. If the fog switch is pressed during operation 122, a fog machine (not shown) connected in line with the lights (not shown) through the light connector 15 may be turned on at operation 123 if it is not already on at operation 122. If it is already on, the switch press at operation 121 will cause the fog machine to turn off in operation 124.

After polling all of controller 10's switches 13A thru 13F and play list events as described, if the end of the audio file is not reached at operation 126, the process will repeat again at operation 107. Once the audio file is done playing, if the end of the play list has not been reached at operation 127, the next song will begin playback in operation 106. Once the play list is complete at operation 128, the program waits for a user command in operation 101.

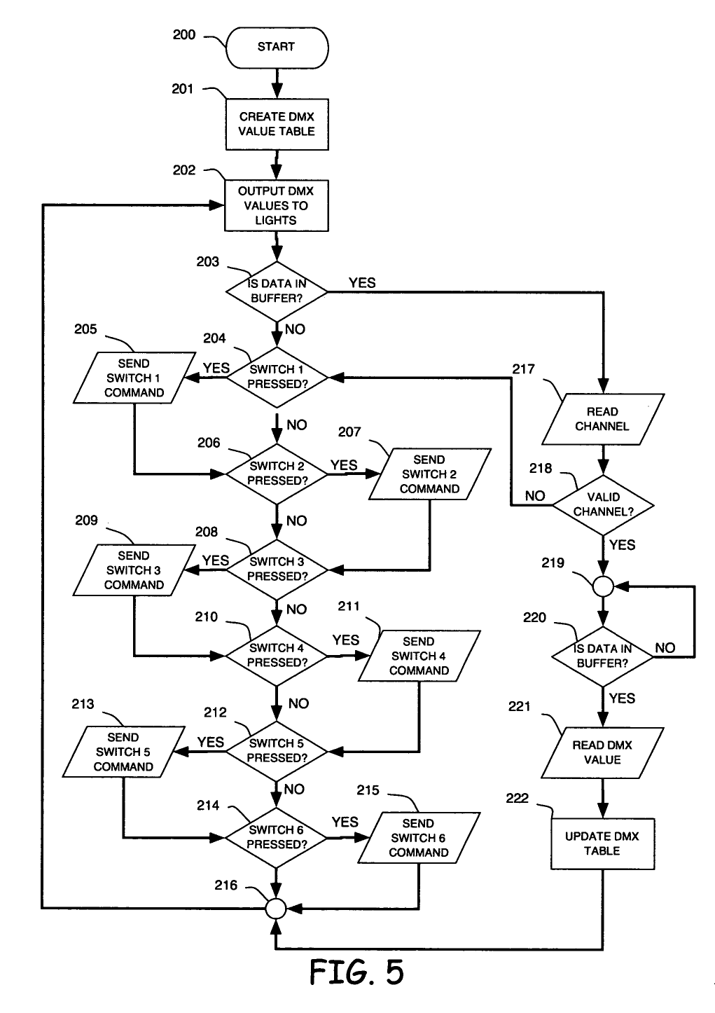

FIG. 5 shows the structure of the firmware that resides on circuit board 16 of controller 10. The programming on circuit board 16 is intended to receive light data from computer 11 and relay it as DMX512 data out light connector 15. Another function of this firmware is to detect switch 13A thru 13F presses and relay a corresponding command to computer 11 so that computer 11 may react to the command sent.

While the foregoing is a general description of the function of the firmware on circuit board 16, the following is a detailed description of how it works. When the firmware is started at operation 200 by powering controller 10 through interface cable 17 to computer 11, the firmware first builds a DMX512 table in operation 201 that holds initially empty values for all DMX512 channels. The DMX512 data is sent in operation 202 to light connector 15. If data is available during operation 203 from computer 11, the data will be read in operation 217 as a DMX512 address. If it is a valid address in operation 218, control passes through junction 219 and waits for more data to be read in operation 220. When more data is received, it is read as DMX512 data in operation 221 that corresponds with the previously read light address. The DMX512 table is then updated in operation 222 and control is passed through junction 216 and back to the light data output routine at operation 202 where the revised DMX512 table is sent out of light connector port 15.

If there is no data available for reading during operation 203, the status of switch 1 is read at operation 204. If it is pressed, a command is sent in operation 205 back to computer 11. The status of switch 2 is next read in operation 206. If it is pressed, a command is sent back to computer 11 in operation 207. The status of switch 3 is next read in operation 208 and if pressed, a command is sent back to computer 11 in operation 209. The status of switch 4 is next read in operation 210 and if pressed, a command is sent back to computer 11 in operation 211. The status of switch 5 is next read at operation 212 and if pressed, a command is sent back to computer 11 in operation 213. The status of switch 6 is finally read in operation 214 and if pressed, a command is sent back to computer 11 in operation 215. After all switches 13A thru 13F have been polled, control is passed through connector 216 and back to the DMX512 output routine in operation 202.

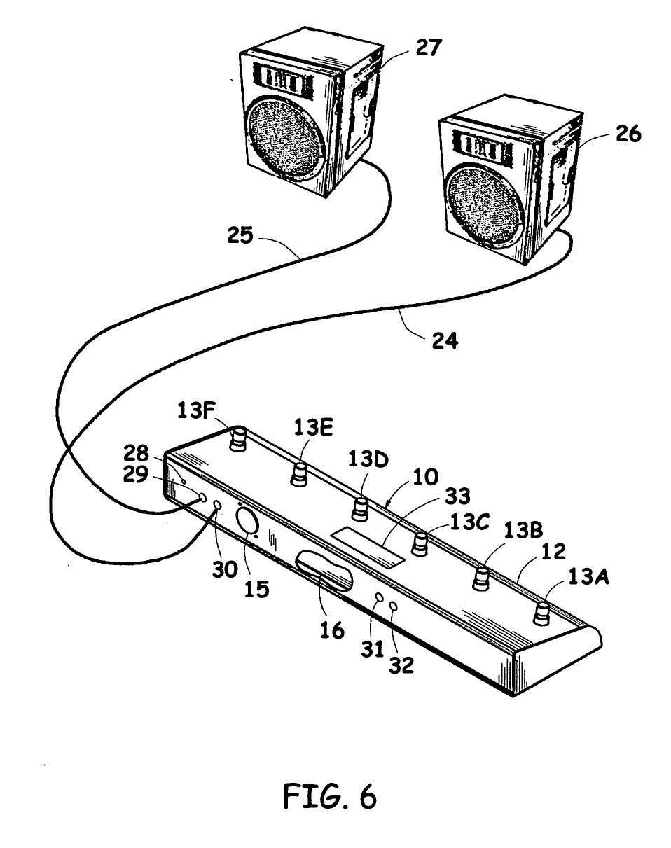

FIG. 6 illustrates an alternative embodiment of the invention where the show controller 10 is an autonomous unit. In this embodiment, there is no external computer 11, but instead, all control and audio playback, mixing, and amplification functions are done by electronic circuitry on circuit board 16. A liquid crystal display 33 is mounted on housing 12 to give the operator visual feedback of the play list 39 operation.

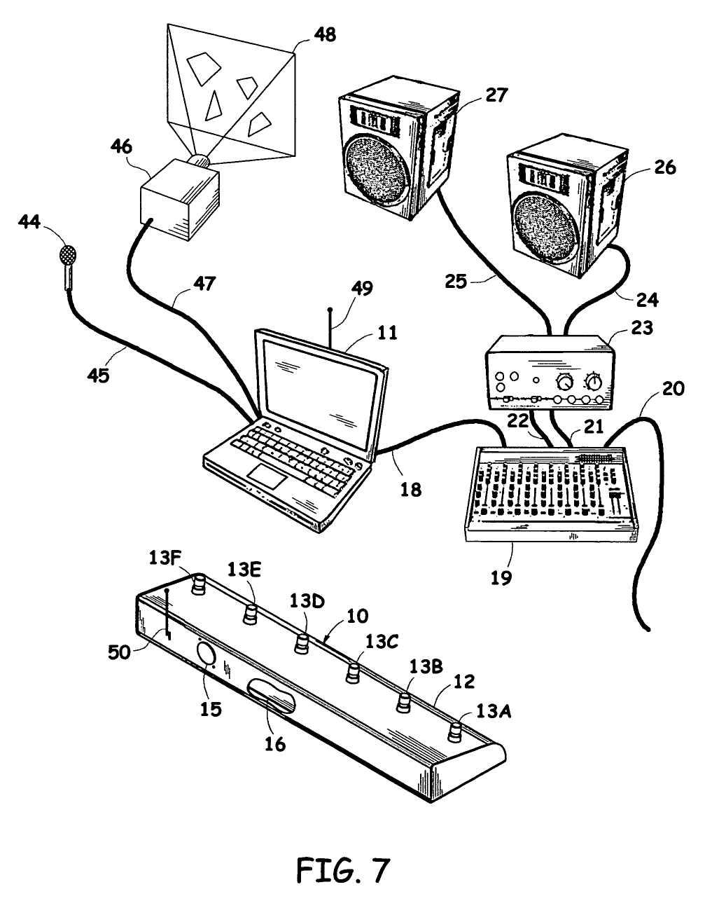

FIG. 7 shows another embodiment of the invention where computer-generated graphics 48 are displayed with a video projector 46 that is connected to the computer 11 with a video cable 47. A microphone 44 is used to sample the audio in the room, and the graphics 48 are generated based on this input that is supplied to the computer 11 through the microphone cable 45.

A microphone 44 is used to sample the audio in the room, and supply the audio to computer 11 by microphone cable 45. Computer 11 may then generate graphics 48 that are based on this audio thus provided by microphone 44. Microphone 44 may also used to provide feedback to the circuit board 16 to control the lighting, effectively making some or all of the lights sound-activated. Another approach that may be employed is to have computer 11 merely analyze the audio that it is playing on its play list 39, and generate graphics 48 and sound-activated light events from it.

Also illustrated in FIG. 7 is a wireless connection between controller assembly 10 and computer 11. This is done by installing a wireless transceiver 49 in computer 11 and a second wireless transceiver 50 in controller assembly 10. In this manner, controller assembly 10 may be used on stage without the impediment of computer interface cable 17.

Live audio from the onstage performer is routed to the live audio connector 31 of FIG. 7. Mixing of this audio signal with the play list audio tracks is accomplished on circuit board 16. The play list audio tracks reside in memory on circuit board 16 and are downloaded from a computer (not shown) via external interface connector 32. Similar to the preferred embodiment, it too is conceivable that multiple live audio connectors 31 may be incorporated so as to mix multiple sources with the play list audio tracks.

The foregoing descriptions of the preferred embodiments of the invention have been presented for purposes of illustration and description. It is not intended to be exhaustive or to limit the invention to the precise form disclosed, and obviously many modifications and variations are possible in light of the above teachings. The embodiments were chosen and described in order to best explain the principles of the invention and its practical application to thereby enable others skilled in the art to best utilize the invention in various modifications as are suited to the particular use contemplated. It is intended that the scope of the invention be defined by the claims appended hereto.

1. A system for controlling a performing arts show, comprising:
(a) a means for playing lists of audio tracks and lighting sequences that are timed to said audio tracks,
(b) a body containing a plurality of switches, and
(c) a means for controlling lights in response to said lighting sequences,
whereby said switches control the starting and stopping of said lists of audio tracks and lighting sequences.

2. A system as described in claim 1, further including a means for displaying lyrics that are timed to said audio tracks.

3. A system as described in claim 1 wherein said switches also control the volume of said audio tracks' playback.

4. A system as described in claim 1 wherein said switches also control the selecting of the current item on said lists for playback.

5. A system as described in claim 1, further including a means to mix live audio with said audio tracks.

6. A system as described in claim 1 wherein said means for controlling lights uses the DMX512 protocol as described by the United States Institute of Theatre Technology.

7. A system as described in claim 1 wherein said means for controlling lights uses MIDI signals.

8. A system as described in claim 1 wherein said switches are foot operated.

9. A system as described in claim 1 wherein said means for playing lists of audio tracks and lighting sequences is a microprocessor that is integral to said body containing a plurality of switches.

10. A system as described in claim 1 wherein said body containing a plurality of switches is connected via a wireless connection to said means for playing lists of audio tracks and lighting sequences.

11. A system as described in claim 1 wherein said lighting sequences contain sound-activated events.

12. A system as described in claim 11 wherein said means for playing lists of audio tracks and lighting sequences also analyzes said audio tracks to trigger said sound-activated events.

13. A system as described in claim 11, further including a microphone, whereby said sound-activated events are triggered by output from said microphone.

14. A system as described in claim 1, further including a method for generating and a means for displaying computer graphics in synchronization with said audio tracks.

15. A system as described in claim 14 wherein said display means is a projector.

16. A system as described in claim 14 wherein said computer graphics generation method is based upon a prescribed algorithm that is a function of the audio signal from said audio tracks.

17. A system for controlling a performing arts show, comprising:
(a) a means to play lists of audio tracks, and
(b) a body containing a plurality of foot operated switches,
whereby said foot operated switches control the starting, stopping, and the selection of said audio tracks.

18. A system as described in claim 17, further including a method of displaying lyrics in synchronization with said audio tracks.

19. A system as described in claim 17 wherein said means to play lists of audio tracks is a microprocessor that is integral to said body containing a plurality of foot operated switches.

20. A system as described in claim 17 wherein said body containing a plurality of foot operated switches is connected via a wireless connection to said means to play lists of audio tracks.

21. A method for controlling a performing arts show comprising:
(a) providing a means for playing lists of audio tracks and lighting sequences that are timed to said audio tracks,
(b) providing a body containing a plurality of switches, and
(c) providing a means for controlling lights in response to said lighting sequences,
whereby said switches control the starting and stopping of said lists of audio and lighting sequences.

22. A method for controlling a performing arts show comprising:
(a) providing a means to play lists of audio tracks, and
(b) providing a body containing a plurality of foot operated switches,
whereby said switches control the starting, stopping, and selection of said audio tracks.
